(19) United States
(12) Patent Application Publication
(10) Pub. No.: US 2008/0253799 A1
(43) Pub. Date: Oct. 16, 2008

(54) Method for converting a non-chipped imaging cartridge to a multi-use chipped imaging cartridge

(75) Inventor: Anthony Causey, Fuquay Varina, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/786,004

(22) Filed: Apr. 10, 2007

(51) Int. Cl. G03G 15/00

(52) U.S. Cl. 399/109

(57) ABSTRACT

Techniques are provided for modifying a non-chipped starter cartridge intended for an initial one time use within a new printer to a chipped non-starter cartridge that may be used in the printer after its initial use after the starter cartridge is modified. Modifying the non-chipped starter cartridge maybe one step in the refurbishment process performed by imaging process cartridge remanufacturers. The modification process may include affixing an electronic chip for communicating between the imaging process cartridge and the printer, the electronic chip having printer and color toner information saved in a memory on the electronic chip.

### FIELD OF INVENTION

The present invention relates to remanufacturing and modifying imaging process cartridges, such as printer toner cartridges, and more particularly to techniques for modifying a non-chipped starter imaging process cartridge into a chipped imaging process cartridge for use in a printer.

### BACKGROUND

Printer cartridges are typically designed to provide the consumer a certain number of print copies before the toner or ink is exhausted. The total number of prints varies depending on the type, quality and density of the print provided by the printer. After all of the toner or ink is spent, the cartridges are either thrown away or recycled.

An emerging industry has developed that deals with the recycling of imaging process cartridges. Typically, the imaging process cartridge is recycled by a cartridge remanufacturer, who receives spent imaging process cartridges and refurbishes them. The refurbishment process entails replacing the worn or nonfunctioning parts, refilling the imaging process cartridge with either toner or ink, and distributing the refurbished cartridges into the marketplace.

Imaging process cartridges are typically designed to fit into one type of laser printer or family of laser printers. For example, the imaging process cartridge for the Okidata C5500 color laser printer may not be compatible with the Okidata C5600 color laser printer. As new printer models are introduced, the printer manufacturer may decide to alter the physical characteristics of the printer cartridge. In some cases the alteration may be an entirely new shape or the printer manufacturer may only change a minor detail such as an indentation or a protrusion on the imaging process cartridge.

Some printer manufacturers may have separate “starter” cartridges that may be shipped with a new printer. These starter cartridges may be intended for a single use only and after a predetermined amount of usage may longer be compatible with the printer. For example, the Okidata C5500 printer is configured to accept only starter cartridges for the initial printer operation. After the cartridges are spent and removed, they are no longer compatible in the printer and are typically replaced by a non-starter cartridge. The Okidata C5500 printer differentiates the starter cartridge from the non-starter cartridge by querying the imaging process cartridge as it is installed into the printer. The non-starter cartridge has an electronic chip that may communicate with the printer. The starter cartridge lacks the electronic chip and does not communicate with the printer. When the Okidata C5500 printer is first turned on, the printer expects its imaging process cartridge query to be ignored. As long as a starter cartridge is initially installed in the Okidata C5500 printer, the printer does not receive a response to its query and as a result may allow the starter cartridge to operate. If the Okidata C5500 printer receives a response to the imaging process cartridge query when it is initially powered on, the printer may display an error message and disable the operation of the non-starter cartridge.

After the starter cartridge is spent, the starter cartridge may not be refilled with toner and reused in the printer. Instead the printer manufacturer requires the use of a non-starter “chipped” cartridge that is intended to replace the starter cartridges. Because the starter cartridges are intended for single use only, the starter cartridges are typically disposed of in the garbage and end up in landfills creating more waste and impacting the environment.

### SUMMARY

The present invention recognizes the inefficiencies created from not recycling starter cartridges and discloses a method to convert non-chipped starter cartridge to a multiple use chipped cartridge usable in the same printer or for use in other printers.

A method of converting a non-chipped starter imaging process cartridge to a chipped imaging process cartridge for use within a printer is disclosed. The method provides the non-chipped starter toner cartridge comprising a toner hopper and a waste bin, the toner hopper separated from the waste bin by a divider disposed generally perpendicular to an agitator axle, the agitator axle protruding through the divider; and, affixing an electronic chip to the waste bin to form the chipped imaging process cartridge, the electronic chip adapted for communicating with the printer when the chipped imaging process cartridge is installed in the printer

A chipped imaging process cartridge for use within a printer, the chipped imaging process cartridge is disclosed. The chipped imaging process cartridge having a toner assembly, the toner assembly further comprising a toner hopper, a waste bin, a divider and an agitator axle, the toner hopper separated from the waste bin by the divider disposed generally perpendicular to the agitator axle, the agitator axle protruding through the divider; and, an electronic chip affixed to the waste bin to form the chipped imaging process cartridge, the electronic chip adapted for communicating with the printer when the chipped imaging process cartridge is installed in the printer.

A more complete understanding of the present invention, as well as further features and advantages of the invention, will be apparent from the following detailed description and the accompanying drawings.

### BRIEF DESCRIPTION OF THE DRAWINGS

FIG. 1 shows an exploded view of an Okidata C5500 starter imaging process cartridge.

FIG. 2 shows an exploded view of a toner assembly of the starter imaging process cartridge of FIG. 1 with the end portion removed.

FIG. 3 shows a closer view of the toner assembly of the starter imaging process cartridge of FIG. 2

FIG. 4 shows a side perspective view of a modified chipped starter cartridge with an electronic chip affixed to the outside of a waste bin in accordance with the present invention.

FIG. 5 shows a side perspective view of a modified chipped starter cartridge with an electronic chip affixed to the inside of the waste bin in accordance with the present invention.

FIG. 6 shows a side perspective view of a modified chipped starter cartridge with an electronic chip affixed to a section of the waste bin in accordance with the present invention.

FIG. 7 shows a toner assembly mounted in a conversion jig in accordance with the present invention.

### DETAILED DESCRIPTION

The following detailed description of preferred embodiments refers to the accompanying drawings, which illustrate specific embodiments of the invention. In the discussion that follows, specific systems and techniques for repairing, manufacturing or remanufacturing an imaging cartridge, such as a toner cartridge are used as examples. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

In the imaging process cartridge refurbishment industry, the spent imaging process cartridges are collected and serviced by toner cartridge remanufacturers. The first step in the refurbishment process is the disassembling of the spent cartridges. Next, the internal components may be separated. Non-functioning components are replaced, and the remaining components, as well as the body of the imaging process cartridge undergo a cleaning process. In the final step the device is reassembled and new toner is added to the toner cartridge. The refurbished device is then packaged and distributed to the consumer. Part of the refurbishment process may include making physical alterations to and installing an electronic chip on the imaging process cartridge. As is described in further detail in subsequent sections, starter cartridges may be altered or converted into multiple use non-starter cartridges.

Within the printer industry, printer manufacturers have employed various techniques to differentiate between different imaging process cartridges. These techniques range from the obvious altering of the physical dimensions and shape of the imaging process cartridge to very subtle indentations or protrusions positioned at certain locations on the imaging process cartridge. For example, some printer manufacturers have installed protrusions such as fins or keys that extend out from the printer's imaging process cartridge compartment and are positioned inside a recess on the imaging process cartridge when the imaging process cartridge is installed inside the printer. In other printer types this arrangement may be reversed. The key may exist on the imaging process cartridge, and the recess may exist inside the imaging process cartridge compartment inside the printer.

In one illustrative example, the black imaging process cartridge used in the Okidata C5500 printer may also be used in the Okidata 5800 printer. The same black imaging process cartridge may also physically fit in the Okidata 5600, 5700 or 6100 with only slight modifications. Similarly, imaging process cartridges containing different color toner may also fit within different imaging process cartridge locations within the same printer with slight physical modifications. These similarities may allow imaging process cartridges of one printer type and one color type to be refurbished into imaging process cartridges configured to fit in different color locations within multiple printers.

In addition to the physical differences, the imaging process cartridge manufacturers may use electronic means to differentiate between imaging process cartridge types. The printer may communicate with an electronic chip which may be installed on the imaging process cartridge. There are two types of imaging process cartridges commercially available for use within the Okidata C5500 color laser printer, a starter cartridge without the electronic chip and a non-starter cartridge with an electronic chip. Starter and non-starter cartridges may exist for each color of toner for each printer.

The Okidata C5500 color laser printer is configured to accept only the starter cartridge as the initial imaging process cartridge. After the toner within the starter cartridge has been depleted, the Okidata C5500 color laser printer is configured to accept only a non-starter cartridge as a replacement. The Okidata C5500 printer differentiates the starter cartridge from the non-starter cartridge by querying the imaging process cartridge when it is installed into the printer. Since the starter cartridge lacks the electronic chip, the starter cartridge is not able to communicate with the printer. When the Okidata C5500 printer is first turned on, the printer expects its imaging process cartridge query to be ignored. As long as a starter cartridge is initially installed in the Okidata C5500 printer, the printer does not receive a response to its query and as a result may allow the starter cartridge to operate. If the Okidata C5500 printer receives a response to the imaging process cartridge query when it is initially powered on, the printer may display an error message and disable the operation of the non-starter cartridge.

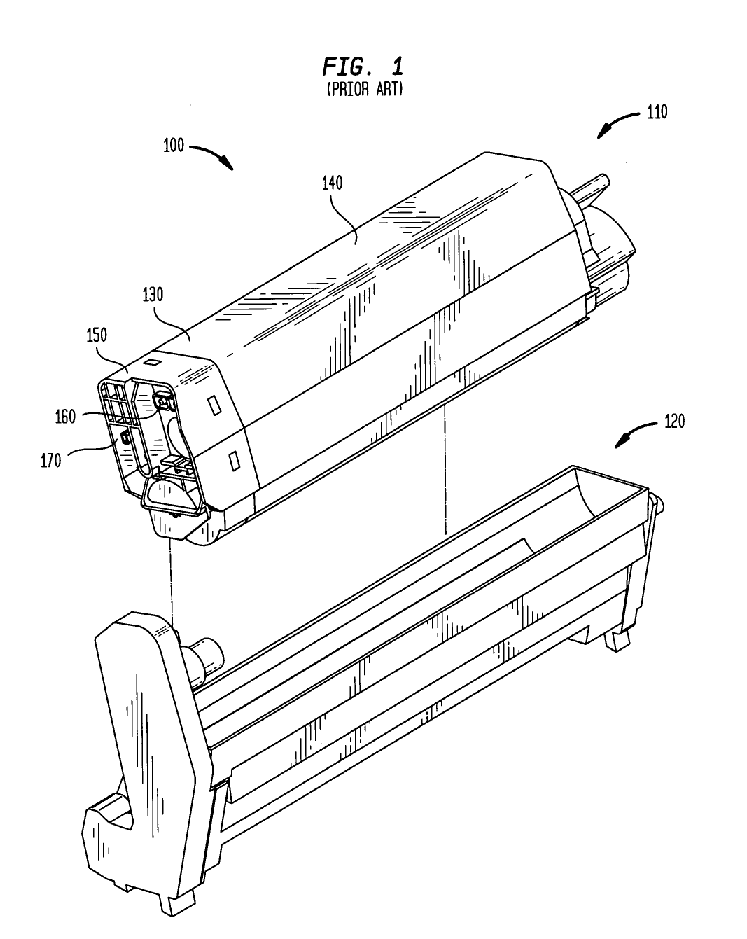

The inventive concepts of the present invention as hereinafter described facilitate the conversion of starter cartridges to non-starter cartridges. To better understand these concepts, a starter cartridge 100 for use in the Okidata C5500 color laser printer is shown in FIG. 1. The starter cartridge 100 has a toner assembly 110 and an organic photo conductor (OPC) assembly 120. Within the OPC assembly 120 is the OPC drum, wiper blades and various gears (not shown for ease of discussion). The toner assembly 110 has a waste bin 130 and a toner hopper 140 as well as an end portion 150. Toner is stored in the toner hopper 140 and is transferred to the OPC drum as the printer prints. Excess toner is scrapped off the OPC drum by a wiper blade and deposited into the waste bin 130.

The starter cartridge 100 as shown in FIG. 1 may be used in any of the four color toner cartridge locations (black, cyan, magenta and yellow) within the printer depending on the configuration of the color selection tabs 160 within the end portion 150. The toner assembly 110 also has printer selection tabs 170 within the end portion 150 that may also be changed in order to allow the toner assembly 110 to be attached to other OPC assemblies 120 for other printer types. The toner assembly 110 may be configured to operate in other printers such as the Okidata C5600, C5700, C6100 and the like with slight physical modifications to the printer selection tabs 170. The color selection tabs 160 and the printer selection tabs 170 align with corresponding color selection indentations (not shown) and printer selection indentations (not shown) located within the OPC assembly 120. For example, a black toner assembly configured using the printer selection tabs 170 and color selection tabs 160 for the Okidata C5500 may mate with a C5500 black OPC assembly. Once the toner assembly 110 is mated with the OPC assembly 120, the starter cartridge 100 may be inserted into any of the four imaging process cartridge locations within a printer depending upon the configuration of the corresponding OPC printer selection tabs and color selection tabs (not shown for ease of illustration).

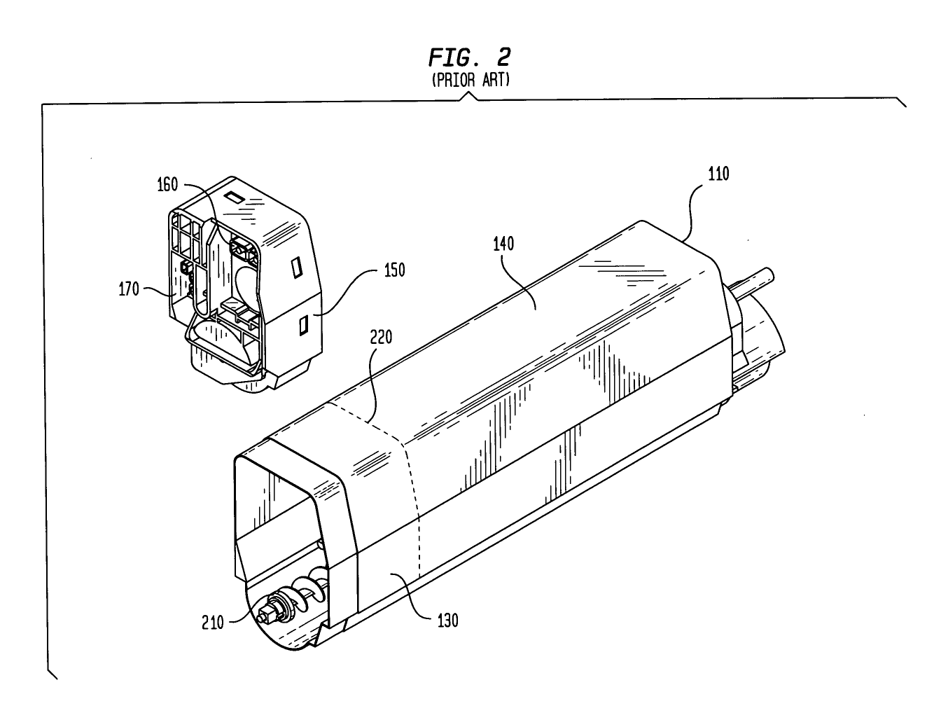

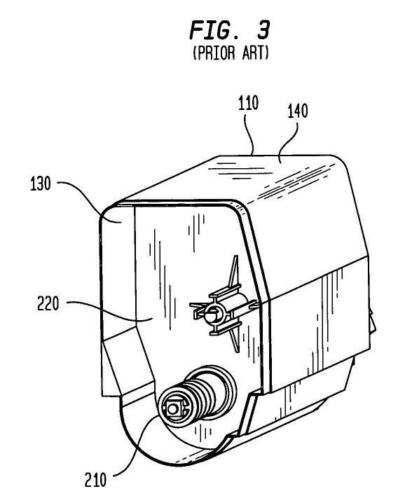

FIG. 2 shows an exploded view of the toner assembly 110 of the starter cartridge 100 with the end portion 150 removed. A divider 220 separates the toner hopper 140 from the waste bin 130. Running through the divider 220 is an agitator axle 210. The agitator axle 210 agitates the toner within the toner hopper 140 as well as the waste toner in the waste bin 130. FIG. 3 shows a closer view of the toner assembly 110 with the end portion 150 removed. As can be seen in FIGS. 2 and 3, the agitator axle 210 is about perpendicular to and protrudes through the divider 220. When the starter cartridge 100 is installed in the printer, the agitator axle 210 is driven by a gear assembly (not shown).

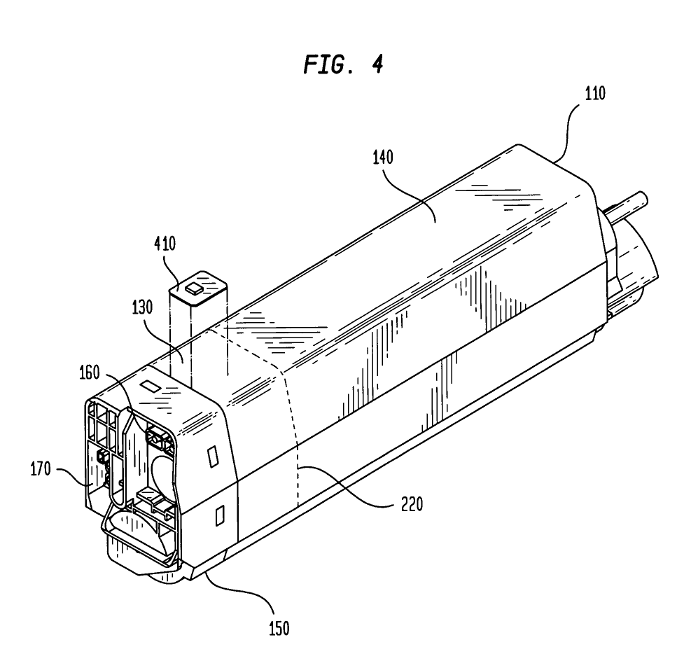

The end portion 150 may be removed as part of the refurbishment process by the remanufacturer to access the internal components of the toner assembly 110. The refurbishment process may include emptying the waste bin 130 and toner hopper 140 of any residual toner, accessing and replacing any worn or broken components and filling the toner hopper 140 with toner. As is described in the discussions of FIGS. 4-6, an electronic chip may be installed on the toner assembly 110. After the toner assembly 110 has been refurbished, the toner assembly 140 may be reattached to a refurbished OPC assembly 120 and subsequently packaged and distributed to potential customers.

Non-starter imaging process cartridges may have a slightly different physical orientation than the starter cartridge 100 displayed in FIGS. 2-3. Specifically, the waste bin and the toner hopper of the non-starter cartridge may be orientated differently than the starter cartridge. For example, the non-starter cartridge used in the Okidata C5500 may not have a divider 220 that is about perpendicular to the agitator axle 210. Instead, the waste bin and toner hopper in the toner assembly of the non-starter cartridge may be separated by a divider which is positioned approximately parallel to the agitator axle.

As mentioned previously, one difference between the starter and non-starter cartridges is the lack of an electronic chip positioned on the starter cartridge 100. The electronic chip used in the non-starter cartridge may communicate with the printer using radio frequency (RF) techniques. The electronic chip may contain an RF antenna facilitating the transmission and reception of data between the non-starter cartridge and the printer. In an alternative embodiment, the non-starter cartridge may utilize a direct contact interface. In this embodiment, the direct contact interface may have one or more electrical contacts positioned on the non-starter imaging process cartridge. The contacts on electronic chip may align with complementary contacts in the printer's imaging process cartridge compartment. When the imaging process cartridge using the direct contact electronic chip is installed in the printer, the electrical contacts on the electronic chip are in electrical contact with the complementary printer electronic contacts. Using direct contacts, data may be transmitted and received by the printer and the electronic chip through the electrical contacts.

In one embodiment, the electronic chip may have a processing circuit interfacing with a memory and a printer interface circuit. The printer interface circuit is responsible for the communication between the electronic chip and the imaging process cartridge. The processing circuit receives the information sent from the printer and process the information. Processing the information may include sending preloaded data from certain memory locations. The electronic chip may contain imaging process cartridge specific data within the memory corresponding to a color of toner as well as the printer type, imaging process cartridge serial number, the number of revolutions performed by the OPC drum, the manufacturing date, the number of pages printed (page count), percentage of toner remaining, yield (expected number of pages), toner-out indicator, toner low indicator, and the like. The electronic chip installed on the non-starter black cartridge for the Okidata C5500 color laser printer may contain a specific value saved in a specific memory location within the memory that corresponds to black toner. If the printer reads an incompatible value from this location, the printer may disable the imaging process cartridge and display an error message on the printer display.

FIG. 4 displays a toner assembly 110 with the end portion 150 attached. The toner assembly displayed in FIG. 4 may have undergone the refurbishment process. As a last step of the refurbishment process, an electronic chip 410 may be installed on the toner assembly 110 of the starter cartridge 100. The electronic chip 410 may be the same chip that is installed on the non-starter cartridge. As shown in FIG. 4, the electronic chip 410 may be positioned on the toner assembly 110 on an outer surface of the waste bin 130. Installing an electronic chip 410 in the location on the toner assembly 110 allows a refurbished starter cartridge 100 to function as a non-starter (i.e. a multiple use) cartridge. Depending on the information stored in the memory of the electronic chip 410 as well as the physical configuration, the chipped starter cartridge may be installed in different imaging process cartridge compartments for different printers.

In order to function, the electronic chip 410 is positioned on the toner assembly 110 in a location that allows the electronic chip 410 to communicate with the printer when the chipped starter cartridge is installed in the printer. If the electronic chip 410 employs an RF communication scheme, the electronic chip 410 must be within range of the printer's receiver and transmitter. For the Okidata C5500 color laser printer, the electronic chip 410 may be positioned on the waste bin 130 of the toner assembly 110 away from the agitator axle 210. The electronic chip 410 may be affixed to the outside of the waste bin 130 of the toner assembly 110 using glue, epoxy, tape or any suitable securing method.

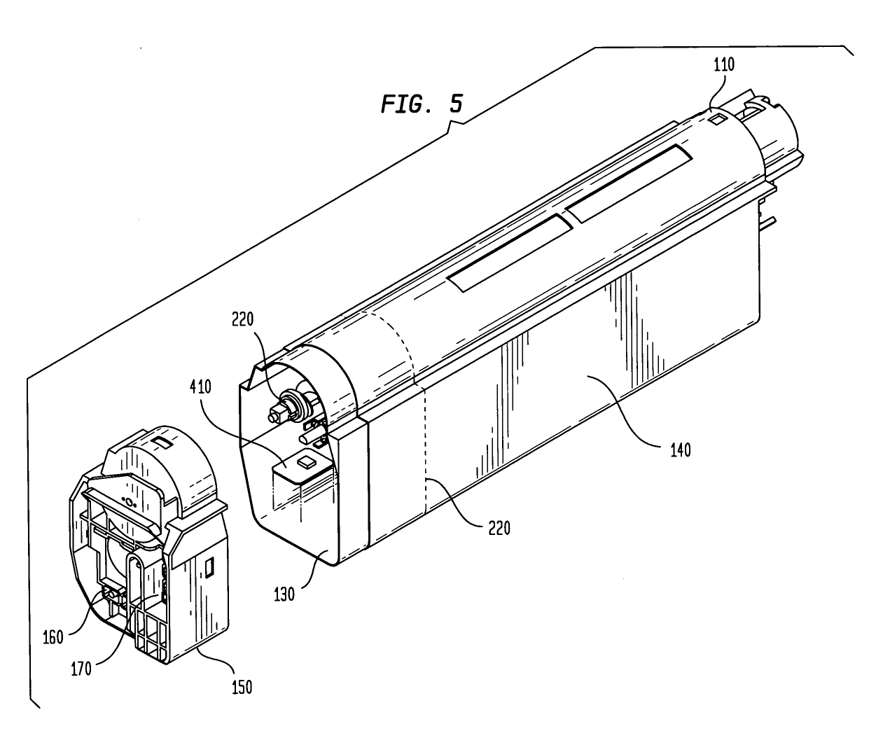

In an alternative embodiment, the electronic chip 140 may be mounted on the inside of the waste bin 130, away from the agitator axle 210 as displayed in FIG. 5. The orientation of the toner assembly 110 in FIG. 5 is rotated about 180 degrees from the view of the toner assembly 110 in FIG. 2. In the embodiment of FIG. 5, the RF communication scheme of the electronic chip 410 transmits and receives information through the wall of the waste bin 130. In this embodiment, the electronic chip 410 may need to be sealed in order to prevent any toner that may collect in the waste bin 130 from affecting the performance of the electronic chip 410. The electronic chip 410 may be affixed to the inside of the waste bin 130 using glue, epoxy or other suitable securing means.

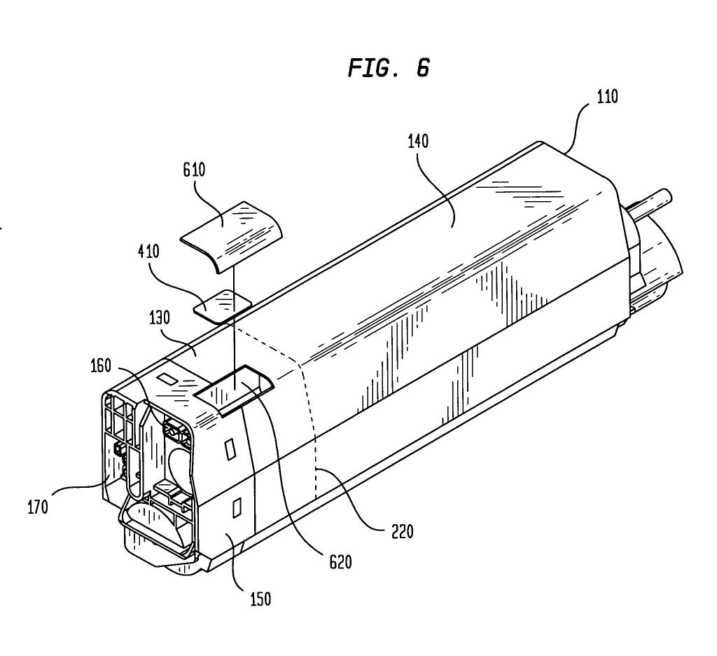

In yet another embodiment as displayed in FIG. 6, a section 610 of the end portion 150 and the waste bin 130 may be removed creating an opening 620. The electronic chip 410 may be installed on the inside of the section 610 and the section may be reattached to the toner assembly 110. In this embodiment, the end portion 150 may not need to be removed in order to attach the electronic chip 410. When the section 610 is reattached to the toner assembly, the seams of the section 610 may need to be sealed tight. By sealing the section 610, any excess toner in the waste bin 130 may not leak through the seam created by attaching the section 610 to the toner assembly 110. Alternatively, the section 610 may be replaced with a plug or other piece which may fit around the opening 620. The plug may be designed with a recess for attaching the electronic chip 410. In this example, the plug with the electronic chip 410 attached thereto may be positioned flush with the top of the toner assembly 110.

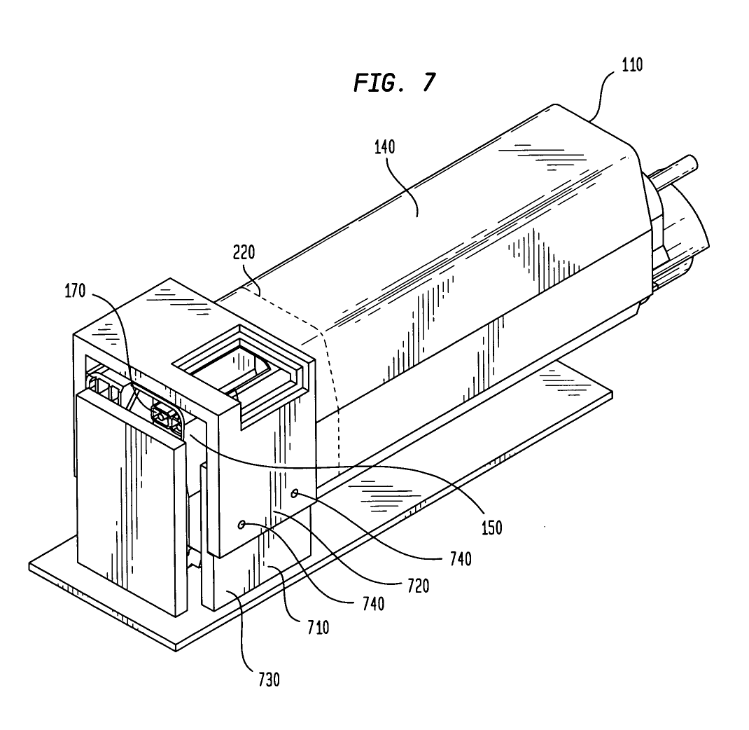

FIG. 7 displays a conversion jig 710 that may be used by a remanufacturer to cut out the section 610 as shown in FIG. 6. The toner assembly 110 may be secured in place when an upper securing member 720 is mated with a lower securing member 730. The upper and lower securing members 720 and 730 may be secured to each other by inserting cotter pins 740 that extend from the outer surface of the upper securing member 720 through the lower securing member 730. Once secured in place, a ROTOZIP™ tool, a Dremmel or other cutting implement may be used to cut out the section 610.

The inventive concepts of the present invention may be applied to brand new starter cartridges. In some instances it may be economically feasible to purchase a new printer remove the new starter cartridges, modify the new starter cartridges to multiple use non-starter cartridges and resell the modified cartridges. Making this example economically feasible is the high retail value of the non-starter cartridges when compared to the price of the new printer. What makes this option advantageous is ability to convert the starter cartridge to a non-starter cartridge without having to complete a full refurbishment process on the starter cartridge. The electronic chip 410 may be attached to the toner assembly 110 without having to break the toner seals on the starter cartridge 100.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of converting a non-chipped starter imaging process cartridge to a chipped imaging process cartridge for use within a printer, the method comprising:
providing the non-chipped starter imaging process cartridge comprising a toner hopper and a waste bin, the toner hopper separated from the waste bin by a divider disposed generally perpendicular to an agitator axle, the agitator axle protruding through the divider; and,
affixing an electronic chip to the waste bin to form the chipped imaging process cartridge, the electronic chip adapted for communicating with the printer when the chipped imaging process cartridge is installed in the printer.

2. The method of claim 1 wherein the electronic chip communicates to the printer using RF (radio frequency) communication.

3. The method of claim 1 wherein the electronic chip communicates to the printer using direct contact communication.

4. The method of claim 1 wherein the electronic chip is affixed to the outside of the waste bin.

5. The method of claim 1 wherein the electronic chip is affixed to the inside of the waste bin.

6. The method of claim 1 further comprising the step of creating an opening in the waste bin, wherein the electronic chip is attached to a plug which is inserted into the opening.

7. The method of claim 1 wherein the electronic chip further comprises a memory.

8. The method of claim 7 wherein the memory contains data corresponding to a printer type and a toner color.

9. The method of claim 1 wherein the imaging process cartridge further comprises a toner assembly wherein the toner hopper and waste bin are positioned on the toner assembly.

10. A chipped imaging process cartridge for use within a printer, the chipped imaging process cartridge comprising:
a toner assembly, the toner assembly further comprising a toner hopper, a waste bin, a divider and an agitator axle, the toner hopper separated from the waste bin by the divider which is disposed generally perpendicular to the agitator axle, the agitator axle protruding through the divider; and,
an electronic chip affixed to the waste bin to form the chipped imaging process cartridge, the electronic chip adapted for communicating with the printer when the chipped imaging process cartridge is installed in the printer.

11. The chipped imaging process cartridge of claim 10 wherein the electronic chip communicates to the printer using RF (radio frequency) communication.

12. The chipped imaging process cartridge of claim 10 wherein the electronic chip communicates to the printer using direct contact communication.

13. The chipped imaging process cartridge of claim 10 wherein the electronic chip is affixed to the outside of the waste bin.

14. The chipped imaging process cartridge of claim 10 wherein the electronic chip is affixed to the inside of the waste bin.

15. The chipped imaging process cartridge of claim 10, wherein the electronic chip is attached to a plug which is inserted into an opening on the waste bin.

16. The chipped imaging process cartridge of claim 10 wherein the electronic chip further comprises a memory.

17. The chipped imaging process cartridge of claim 16 wherein the memory contains data corresponding to a printer type and a toner color.
